(19) United States
(12) Patent Application Publication
(10) Pub. No.: US 2013/0073447 A1
(43) Pub. Date: Mar. 21, 2013

(54) FUNDING SYSTEM FOR VERIFIED FUNDS TRANSFER IN A GAMING ENVIRONMENT

(71) Applicant: Michael Smith, Las Vegas, NV (US)

(72) Inventor: Michael Smith, Las Vegas, NV (US)

(21) Appl. No.: 13/233,896

(22) Filed: Sep. 15, 2011

(51) Int. Cl. G06Q 40/00

(52) U.S. Cl. 705/39

(57) ABSTRACT

A funding system for gaming establishments provides verified fund transfers from a player's personal account to the gaming establishments. The funding system may utilize a funding account for holding player funds and a player tracking account. The funding account may be owned by the player and receive funds from the player's personal accounts. Fund transfers between the funding account and a gaming establishment may be verified in a verification process comprising one or more verification steps. This reduces or eliminates unauthorized or unintended fund transfers. The funding system may associate a player's funding account with the player's player tracking account. In this manner, a player may utilize a player tracking card to transfer funds between his or her funding account and a gaming establishment.

### BACKGROUND OF THE INVENTION

1. Field of the Invention

The invention relates to electronic funds transfer systems and in particular to a verified account and player card for funds transfer with chargeback prevention.

2. Related Art

Though businesses enjoy benefits from receiving funds via credit cards there are numerous drawbacks. For one, the business must pay a portion of each transaction to the card issuer. In addition, some issuers charge a transaction fee despite such transactions being fully electronic and automated.

Worse yet, card issuers allow card holders to dispute charges in a process known as a chargeback. During a chargeback funds are removed from the business's account and placed in the card holder's account. The business must then justify the charge or the card holder will keep the funds even though goods or services have been delivered to the card holder.

Though useful in situations involving actual fraud, from the perspective of businesses, there is little to prevent card holders from disputing a charge. Accordingly, the chargeback, though useful in situations where actual fraud has occurred, has been used improperly by card holders.

For example, one area where chargebacks are extremely problematic is in the area of casino-style wagering. As detailed below, gamblers who have remorse about losing money after engaging in wagering frequently attempt to recover their losses by seeking a chargeback.

From the discussion that follows, it will become apparent that the present invention addresses the deficiencies associated with the prior art while providing numerous additional advantages and benefits not contemplated or possible with prior art constructions.

### SUMMARY OF THE INVENTION

A funding system for transferring player funds to and from a gaming establishment is disclosed herein. The funding system provides a number of benefits. For instance, the funding system may utilize a funding account that is owned by the player to transfer funds to a gaming establishment. The player's funds may be first transferred to this funding account from another personal account, and then from their personal account to a player's trust org or casino account. The player may then make wagers using funds in their casino account. The funding system also provides a verification process that verifies player intent to transfer and player authorization prior to the transfer of funds between those accounts.

Since these transfers (from a player's personal banking account to their funding account and then from their funding account to their casino account) are between a player's own accounts, and because the transfers must be verified by the player, it is unlikely that the transfer can be deemed improper or unauthorized. In addition, chargebacks are reduced or eliminated because the player's transfers of funds to their funding account and then to their casino account are between the player's own accounts (and do not comprise merchant transfers). Further, the transfer of funds from the player's casino account to the casino is not a covered merchant transfer because the player's casino account is governed by the casino and not the banking system. This makes such fund transfers safer and reduces or eliminates the need for chargebacks or the like.

The funding system may have a variety of configurations. For instance, in one exemplary embodiment a funding system may comprise a player card server configured to accept application form information and to provide a player tracking account identifier, a platform server, and one or more access terminals or devices. The player card server may also be configured to issue a player tracking card to a player. A financial server configured to receive the application form information and to provide the funding account identifier may also be included.

The platform server may be configured to receive the player tracking account identifier from the player card server and a funding account identifier from a financial institution via one or more communications devices. The platform server may also associate the funding account identifier with the player tracking account identifier such that they may be retrieved together.

The access devices may be configured to receive the player tracking account identifier and to request a fund transfer utilizing the funding account identifier. The fund transfer may send funds from a funding account identified by the funding account identifier to a player's casino account, from which funds may be wagered and transferred to a gaming establishment's bank or other account. The funding account may be configured to receive funds from a player's personal account. It is noted that the funding account and the personal account are preferably both owned by the player.

It is noted that the access devices are configured to verify the fund transfer at least one time before the funds are transferred from the funding account. For example, the access devices may present a plurality of questions to verify the fund transfer before the funds are transferred from the funding account. One or more of the access devices may be configured to present the application form to one or more players and to accept the application form information.

In another exemplary embodiment the funding system may comprise a funding server configured to provide funds to a gaming establishment. The funding server may comprise one or more communications devices configured to receive a funding account identifier and a player account identifier. The funding account identifier identifying a particular funding account and the player account identifier identifying a particular player account. The communications devices may be in communication with a financial institution's server to communicate transfer instructions to transfer funds from the funding account to the gaming establishment.

One or more storage devices may be configured to store the funding account identifier and the player account identifier such that the funding account identifier and the player account identifier are associated with one another. The storage devices may also store authorization information, which may be provided along with the funding account identifier to transfer funds from the funding account to the gaming establishment. It is noted that storage devices may also store application form information received from a player.

One or more processors may be provided as well. The processors may be configured to receive the player account identifier and retrieve the associated funding account identifier. The associated funding account identifier may be used by the processors to transfer funds from the funding account to a gaming establishment. The processors may also verify a transfer of funds with a player one or more times before funds are transferred from the funding account to the gaming establishment. For example, the processors may verify the transfer of funds by verifying answers to one or more questions received from a player. As another example, the application form information may include one or more answers to one or more questions, wherein the processors compare one or more answers from a player with the answers to verify the fund transfer.

Various methods of funding a gaming establishment are disclosed herein as well. For example, in one embodiment a method of funding gaming establishment transactions comprises receiving player identification information via an application form, sharing the player identification information with a financial institution to establish a funding account at the financial institution, and providing a player account and player tracking card to a player identified in the player identification information. The player account and funding account may be associated with one another so that they may be retrieved together. The funding account may be established with the player as its owner. In general, funds will be received at the funding account from a player's personal account.

The method may also include receiving a player account identifier from the player tracking card, verifying a fund transfer by requesting verification information from a player one or more times, and transferring funds from the funding account associated with the player account identified by the player account identifier. It is noted that the verification information may be requested a plurality of times. The verification information may be first received via the application form.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating an exemplary funding system.

FIG. 2 is a block diagram illustrating an exemplary funding system.

FIG. 3 is a block diagram illustrating an exemplary funding platform.

FIG. 4 is a flow diagram illustrating an exemplary application process.

FIG. 5 is a flow diagram illustrating an exemplary funding process.

FIG. 6 is a block diagram illustrating an exemplary funds transfer via the funding system.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, a funding system in accordance with the invention allows funds to be electronically transferred by players to a gaming establishment for the purpose of making one or more wagers. The benefits of the funding system include the convenience of electronic funds transfers versus cash, check, or other transactions. In contrast to credit cards, however, the gaming establishment is protected against illegitimate chargebacks when using the funding system to accept funds. In addition, the funding system may provide player cards that provide additional benefits to players and gaming establishments in addition to the benefits of electronic funds transfers.

The prevention of illegitimate chargebacks is highly advantageous, especially to gaming establishments. In traditional credit card issuer and gaming establishment relationships, the card issuer requires the gaming establishment to agree to the chargeback process where funds can be automatically removed from the gaming establishment's account and given back to a player. The removed funds are retained by the player unless the gaming establishment can show the transaction was valid.

A gaming establishment is a unique type of entertainment venue, which is why gaming establishments are sought after by adults from virtually every walk of life. For one, alcoholic beverages are readily available. In addition, the environment in a gaming establishment is often interesting, exciting, and fast paced especially when one is wagering on his or her game of choice. Despite the fact that players may have fully enjoyed their time at the gaming establishment and experienced the excitement of winning and losing one or more wagering games, there is an incentive for players (especially those experiencing remorse from losing money) to dispute legitimate charges by the gaming establishment. Given the exciting fast paced entertainment environment provided by gaming establishments and aura surrounding gaming establishments, credit card issuers may be more willing to grant illegitimate chargebacks against the gaming establishments. This is highly undesirable as it reduces the profits rightfully earned by a gaming establishment.

A funding system in accordance with the present invention will now be described with regard to FIG. 1. FIG. 1 is a block diagram illustrating an arrangement of components or parts of the funding system. As can be seen, the funding system 104 may utilize various currency and other accounts held at various institutions. The funding system 104 may also provide a facility to link such accounts such that funds may be transferred from a funding account via another account, such as a player card account or trust account at a gaming establishment or the gaming establishment's financial institution.

As shown in FIG. 1, the funding system 104 may be formed by or utilize various elements. FIG. 1 also illustrates exemplary relationships between these elements. To illustrate, a bank or other financial institution 116 may provide one or more funding accounts 128 (e.g., debit card, checking, savings, or other accounts) for holding and transferring a player's funds. The financial institution 116 may issue a debit card 124 or the like through which funds in the funding account 128 and the funding account itself may be accessed.

A player card center 120 may provide player tracking accounts for players and gaming establishments. The player card center 120 may be its own entity or may be part of a gaming establishment. In one or more embodiments, the player card center 120 may issue player tracking cards 112 for use by players in accessing their player accounts at a gaming establishment. For example, players may accumulate rewards such as player points and redeem such points via their player tracking card 112. A player may be eligible for various prizes through their participation and/or use of a player tracking card 112 at a gaming establishment. In addition, it is contemplated that a player may access a funding account he or she has at the gaming establishment using the player tracking card.

The player tracking card 112 and debit card 124 may have information stored thereon or which is otherwise associated therewith that identifies a player's account at a gaming establishment and/or financial institution 116, respectively. For example, an account number or information which may otherwise identify such an account may be stored or associated on these cards. A player may then access the identified account(s) at their respective places. In one or more embodiments, the player may be prompted to verify access to the accounts, such as by inputting a PIN or other code or password.

A linking platform 108 may be included in the funding system 104 as well. In general, the linking platform 108 associates a player's funding account 128 with his or her player account 132. This may occur in various ways. For example, as shown in FIG. 1, a funding account 128 and player card account 132 are associated via their respective associated debit card 124 and player tracking card 112. The account numbers for the funding account 128 and player account 132 may be linked together to form this association. For example, these account numbers may be associated in a database or other storage medium to link the two together.

A gaming establishment 136 may utilize the services of the funding platform 108, player card center 120, and/or financial institution 116, such as via one or more communication links. For example, as will be described further below, funds may be transferred to a gaming establishment from a players funding account 128 via a player tracking card 112 that was associated with the funding account by the funding platform 108. One or more verification steps may occur prior to executing the transfer to ensure that the transaction is legitimate. This protects the player's funds to greatly reduce, if not eliminate, the need for chargebacks.

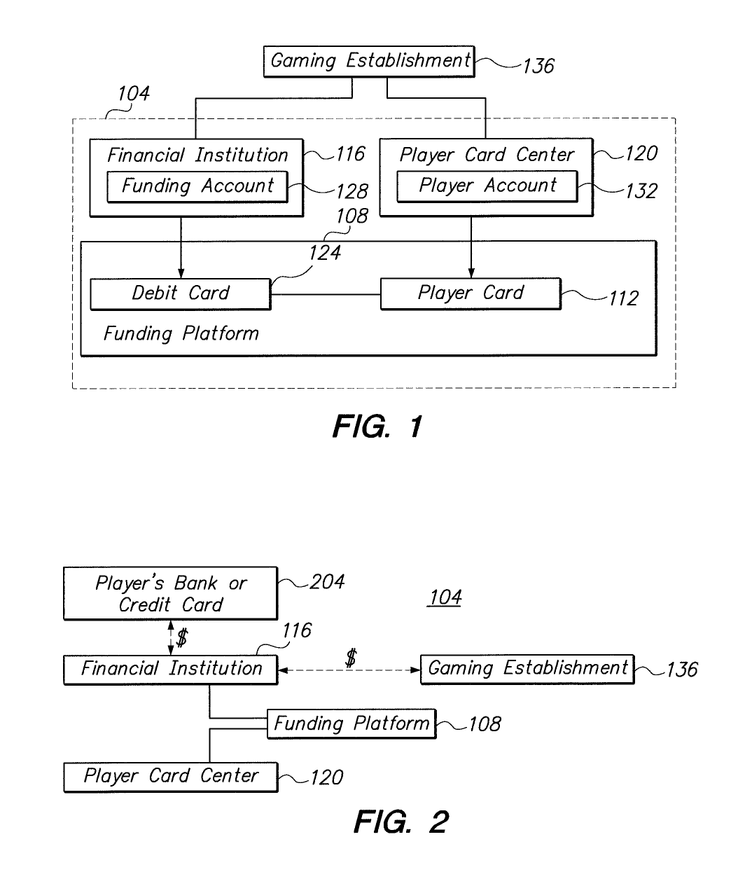

FIG. 2 provides a more detailed view of the funding system 104. In this exemplary embodiment, communication links are shown as solid lines while fund transfers are shown as dashed lines. It is noted that although they are shown as having particular communication links, additional communications links may be provided to foster direct communication between elements of the funding system 104.

As can be seen from FIG. 2, the funding platform 108 may function as a hub to orchestrate fund transfers between a player, various accounts, and the gaming establishment 136. This may be accomplished via communication between the funding platform 108 and the financial institution 116, player card center 120, and gaming establishment 136. In one or more embodiments, one or more servers or the like at these elements may perform the communications and other operations needed to execute a funds transfer. For example, the funding platform 108 (after receiving verification from a player) may electronically initiate a funds transfer from the financial institution 116 by communicating an account number, amount to be transferred, authorization information, etc. . . . with a server or other device of the financial institution.

As can be seen, the block diagram of FIG. 2 also shows a player's bank 204. This illustrates that funds can be transferred to the financial institution 116 from the player's personal bank 204, such as a person checking or savings account. Alternatively or in addition, funds could be transferred from a credit card account or other account to the financial institution 116. The funds may be transferred electronically or physically, such as by check or cash (i.e., a deposit to the financial institution 116).

As described above with regard to FIG. 1, the transferred funds may be held in a funding account at the financial institution 116. The funding account generally holds funds transferrable to a gaming establishment 136 for the purpose of wagering at one or more wagering games. The funds in the funding account could also be used for purchasing goods and services (e.g., room and board, food, show tickets) at the gaming establishment 136 as well. As disclosed below, in a preferred embodiment, a player transfers funds from their funding account to a player trust or casino account associated with the casino or gaming establishment. The player then wagers funds from that casino account, with wagered funds being transferred to the gaming establishment or casino.

It is noted that a communication link between the financial institution 116 and the funding platform 108 may be used to share account information related to the funding account. For example, the account number may be shared between the funding platform 108 and financial institution in this manner, such as when the player establishes an account. In addition, a communication link between the player card center 120 and funding platform 108 may be used to share account information related to the player account. For example, the player account number may be provided to the funding platform 108 in this manner. It is contemplated that the funding platform 108 may receive account information related to various accounts in other ways. For example, a debit card and/or player tracking card could be used to provide account numbers and other account information to the funding platform 108, such as via a card reader or by manual input. By accepting account information from various sources, the funding platform 108 may associate the player account with the funding account, such as disclosed above.

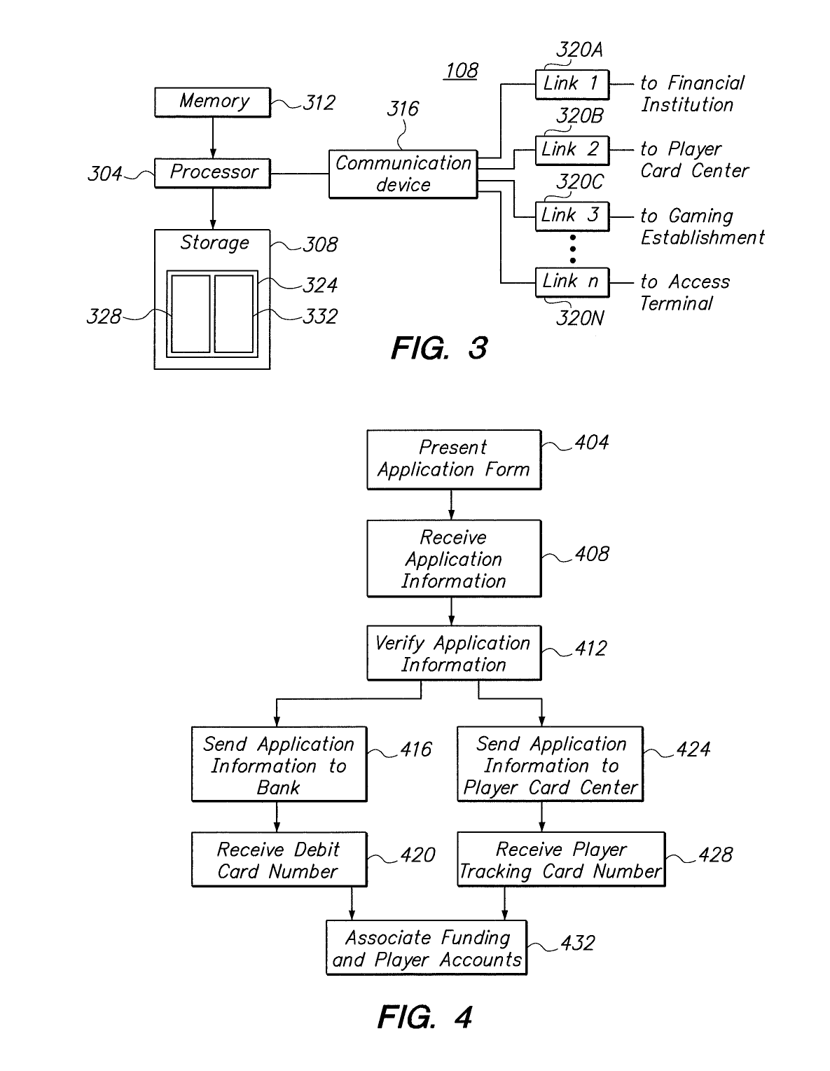

FIG. 3 is a block diagram illustrating an exemplary funding platform 108. In one or more embodiments, the funding platform 108 may be configured as a server having one or more processors 304 that execute instructions to provide the functionality of the funding platform as disclosed herein. It is noted that one or more servers may form a funding platform 108, and that each server may perform separate or similar tasks.

The instructions may be hardwired into the processors 304 and/or retrievably stored on a storage device 308 for execution by the processors. It is noted that the storage device 308 may utilized various data storage technologies (e.g., magnetic, optical, or flash storage) now known or later developed. In addition, a storage device 308 could utilize removable media upon which data is stored. Also, a storage device 308 may be remote from the funding platform 108 that is remotely accessible via one or more communications links (e.g., network attached storage, storage area network, etc. . . . ). The funding platform 108 may also include one or more memory devices 312. Typically these will be temporary storage, such as RAM or cache memory. The memory devices 312 may be used to store various types of data such that it is quickly accessible to a processor 304.

The funding platform 108 may also comprise one or more communication devices 316. The communication devices 316 may be hardware interfaces that allow the funding platform 108 to communicate with other servers or devices. For example, a communication device 316 may be a network interface card. The communication devices 316 may communicate via one or more wired and/or wireless connections, paths or links. In one or more embodiments, the communication devices 316 may be used to execute fund transfers, such as by identifying a source account, a destination account, an amount to be transferred, and/or providing authorization for the transfers.

As shown in FIG. 3, each communication device 316 may be capable of establishing one or more independent communication links 320. It is contemplated that each communication link 320 may be used to communicate with a particular element of the funding system. For example, a first communication link 320A may form a connection with a financial institution while a second communication link 320B may form a connection with a gaming establishment. The player card center and banks or other financial institutions may be connected to the funding platform 108 in this manner as well. It is contemplated that each communication link 320 may utilize one or more communication protocols and that the communication protocols used by the communication links need not be the same. It is noted that, for security or other reasons, multiple communication devices 316 may be provided in some embodiments. One or more or each of these communication devices 316 may provide a single dedicated communication link 320 to a particular element of the funding system.

As stated, the one or more storage devices 308 may store one or more instructions or machine readable code for execution by a processor 304. In one or more embodiments, the storage devices 308 may also store various account information 324 and related associations. It is noted that machine readable code and account information 324 may be stored on physically separate storage media of the one or more storage devices 308 in some embodiments. In other words, machine readable code may be stored on at least one first storage medium while account information 324 may be stored on at least one distinct second storage medium.

The account information 324 may be stored in an organized fashion. For example, the account information 324 may be organized in flat files, tables, cells, rows, and/or columns, such as in a database or other data storage format. It is contemplated that various storage formats may be used as long as the desired fields or other records in the account information 324 can be retrieved when needed.

Account information 324 may comprise various data. For example, in one embodiment, the account information may include player account information 328 and funding account information 332. The account information 324 may also include data to associate or link the player account information 328 and the funding account information 332 such that one may be retrieved along with the other. For example, a particular player's player account information 328 and his or her funding account information 332 may be linked by storing each with the same unique identifier. Both accounts may then be retrieved using the unique identifier. In addition or alternatively, the account information 328,332 or an identifier thereof may be stored in the same row or column (or the like) of a database or other data storage format. For example, an account number for the player and funding accounts may be stored together in a database. In this manner, the player account information 328 can be retrieved along with the funding account information 332, or vice versa.

An example of account information showing exemplary fields or records that may be stored by the account information follows:

Account Information:

1. Player Name

2. Player Address

3. Player Contact Information (e.g., telephone number, email)

4. Player Account Number (or other player account identifier)

5. Funding Account Number (or other funding account identifier)

6. Authorization Information

As can be seen, the account information may include information identifying a player as well as information identifying a player's player account and funding account. It is noted that the account information may also include player tracking information, such as the number of points or other credits a player has earned from wagering or other activity at a gaming establishment.

As detailed herein, casino or gaming establishment preferably also creates a player trust or casino account for accepting funds from the player's funding account and from which funds are wagered to the casino. This player trust or casino account is preferably associated with or identified with the player's tracking account in similar manner to that described above.

Operation of the funding system will now be described. The funding system may provide an application process through which the ability to transfer funds using the funding system is established. In addition, the funding system may provide a transfer process through which funds can be transferred with the funding system (after the application process is complete.

FIG. 4 is a flow diagram illustrating steps that may be executed during an exemplary application process. The steps may be performed on the funding platform or on various other elements of the funding system. For example, one or more web or other servers may be used to provide applications and/or facilitate the application process, as will now be described.

At a step 404, an electronic application form may be presented to a player wishing to sign up for to use the funding system. It is contemplated that the player may be provided one or more incentives by a gaming establishment, such as prizes or gifts, to encourage sign up. The application form may be a web page or other electronic document distributed to the player. For example, the player may receive and fill out the application from on his or her computer or other device. The application form may be hosted on a server of the funding platform such that it may be remotely accessed. Alternatively, the application form may be emailed or otherwise sent to the player to be filled out.

It is noted that the application form may be paper based as well. In such cases, the player may pickup an application form at the gaming establishment, player card center, or other location. Alternatively, the application form may be mailed or faxed to the player.

At a step 408, information requested by the application form may be collected or received at the funding platform. In one embodiment for example, the information may be received from a player's personal computer via a communication device of the funding platform.

The application form may request various types of information. For example, the application form may request player identifying information, such as the player's name, address, phone number, social security number, date of birth, etc. . . . which separately or combined help to identify a particular player. The application form may also request financial information, such as an initial deposit amount, account numbers for one or more of the player's accounts from which funds may be transferred to the funding system. For example, the player may list a bank account from which to transfer funds into and out of the funding system. This information may include a routing number and account number.

The application form may also request verification information. For example, the application form may have one or more questions that only the player may know the answer to. When the player utilizes the funding system later on, the player's identity may be verified by comparing his or her answers to these questions to the answers that were previously given. The verification information may also include one or more images, sounds, or other information that the player may be requested to remember and recall later on to verify his or her identity.

The application form may also request security information. For example, the application form may prompt a player to enter a username and password to prevent unauthorized access to the player's account at the funding system. Some of the security information may be provided to a player. For example, as will be described further below, a player may be issued a player tracking card with an identifier, such as an account number. In these cases, the player may only need to provide a password or PIN since the account number is provided to the player by the funding system.

It is noted that if the application form is not electronic, the information thereon may still be received by the funding platform. For example, at step 408, such information may be manually inputted into the funding system, such as via a keyboard, mouse, and/or other input device. Alternatively, the application could be scanned into the funding platform. One or more character recognition routines may then be executed to determine what information is on the application form.

At a step 412, the information received via the application form may be verified. For example, the funding platform may confirm that all required information has been provided, and if not notify the player to input any missing information. Alternatively or in addition, the funding platform may verify that the information received is in the proper format. For example, the funding platform may verify that phone numbers are numeric. In addition the funding platform may verify that the information is accurate such as by verifying that the zip code and addresses entered reflect a real location, the account number(s) provided, and the like. In one or more embodiments, the funding platform may communicate with an external record or database to perform this verification. For example, the funding platform may communication with a financial institution's server to verify the accuracy of the account numbers entered by the player and to verify ownership of such accounts.

Once the information has been verified 412, the application form may be shared with a bank at a step 416 and a player card center at a step 424. It is noted that the verification step 412 need not occur in all embodiments. This is because the bank and/or player card center may perform their own verification. It is contemplated that the bank and/or player card center may perform their own verification in addition to that performed by the funding platform in some embodiments.

At stated, the information collected via the application form may be shared with a bank at step 416. Typically, the bank will utilize this information to establish funding account complete with a debit card for accessing the account. The funding account will belong to (i.e., be held by) the player. In this manner, the player has control over the funds he or she transfers into the funding account. It is noted that the funding account may be established at a bank or other financial institution capable of creating or generating an account that may be used to electronically transfer funds. For example, such a bank may comprise a bank which is a member of one or more defined financial networks.

At a step 420, once the funding account is established, an account number or other identifier may be sent from the bank (or other financial institution) to the funding platform. For example, the funding account's account number or a debit card number (if not the same) could be sent from the bank to the funding platform at step 420.

As stated, at step 424, information collected from the application form may also be sent to a player card center for establishment of a player account and a player tracking card. For example, player identifying information may be used to setup a player account at the funding platform. Alternatively, this information could be used to setup the player account at a server (or the like) of a gaming establishment. For example, the player identifying information could be shared with a gaming establishment. The gaming establishment may then setup the player account at its facilities.

At a step 428, the funding platform may receive the account number or other identifying information for the player account. If the player account is established on the funding platform this information may be retrieved from a storage device accessible to the funding platform. If the player account is established at a gaming establishment, this information may be requested and received from a server or other system of the gaming establishment.

Once at least the identifying information for the player account and funding account have been received at the funding platform, the accounts may be associated together. In this manner, a player may use his or her player tracking card to transfer funds via the funding account. For example, a player may identify his or her player account through his or her player tracking card. Because of the association between the player account and the funding account, the funding platform can then identify the player's funding account. In this way, the player may effectuate fund transfers via his or her funding account from his or her player tracking card.

As detailed herein, in a preferred embodiment, the funds which are transferred from the player's funding account are first transferred to a player's trust or casino account. The player may then later wager funds from their casino account to the gaming establishment or casino, such as by using their player tracking account to identify themselves to the casino and then using the funds in the associated trust or casino account to place wagers.

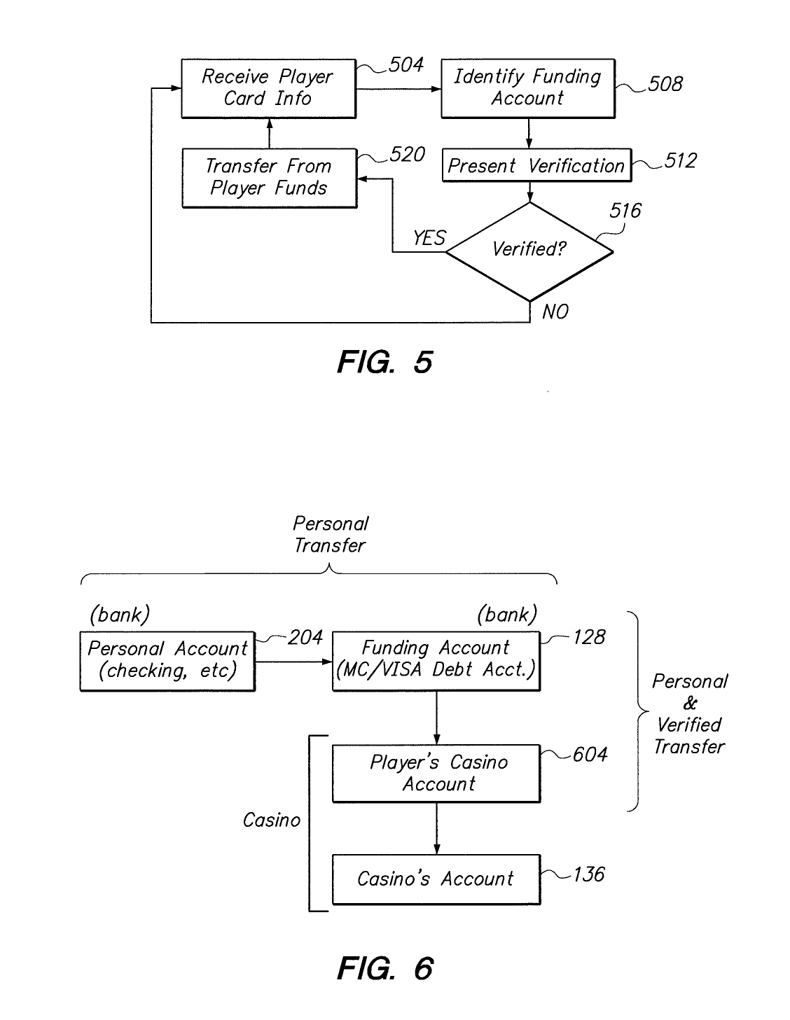

FIG. 5 is a flow diagram illustrating an exemplary fund transfer utilizing the funding system. As with the above, the steps here can be performed by the funding platform or one or more servers. At a step 504, the funding platform may receive player card information, such as a player account number and PIN or other password or authorization information. The player card information may be read from a player tracking card and provided to the funding platform via a kiosk, gaming machine computer, or other access terminal. For example, the player may swipe or scan his or her card at a card reader of a gaming machine, which devices transmits the player card information to the funding platform. Alternatively or in addition, the access terminal may have one or more inputs, such as buttons, through which the player may input player card information such as a player account number. The player may input his or her PIN or other authorization information via the inputs as well.

Once the player card information has been received and access to the player account is verified, such as by comparing the player provided authorization information to that already stored, an associated funding account may be identified. For example, the funding platform may retrieve data from a storage device that identifies a particular funding account that has been associated with the player account.

Funds may then be transferred from the funding account. In one or more embodiments, a verification step or steps may occur prior to effectuating a transfer of funds. For example, at a step 512, one or more verification screens may appear at the access terminal to verify the fund transfer before it may be executed. The verification screens may be retrieved from a remote source such as the funding platform or one or more servers.

In one or more embodiments, the verification screens may utilize the verification information collected via an application form to verify a transfer of funds. For example, a verification screen may ask a player questions such as his or her mother's maiden name, name of his or her first pet, his or her father's middle name, etc. . . . .

At a decision step 516, the player's answers or responses to the verification screens may be evaluated to determine if the player has adequately verified or confirmed that a fund transfer should occur. For example, if the player's responses match those given on his or her application form, this may be deemed an adequate verification. One or more of the verification screens may also request a confirmation that the player desires to transfer funds.

If there is adequate verification at decision step 516, the transfer of funds may occur at step 520. Typically this involves the transfer of a player selected amount of funds from his or her funding account to the gaming establishment, such as to a player account which is associated with or identifies the player, such as one associated with the player's player tracking account. Alternatively, the transfer could be from a player's funding account directly to an account of the casino or gaming establishment. If verification is inadequate, no transfer may be made. The process may then begin again at step 504 with the acceptance or receipt of player tracking card information.

Verification of a transfer is highly beneficial in that it makes it difficult, if not impossible, for a player to claim that he or she did not authorized transfer of funds to the gaming establishment. This is because the player must correctly respond to one or more verification screens before he or she is permitted to make a transfer. In addition, the player may be required to confirm that he or she desires to make a transfer and the amount of the transfer. Thus, unlike credit cards, the player would not be able to easily issue chargebacks which result in the removal of funds from the gaming establishment. This is because the verification screens help ensure that it is the player that is effectuating the funds transfer. In addition, by correctly responding to the verification screens, the player is indicating that he or she is aware that a transfer is going to take place and that such transfer is desired.

FIG. 6 is a simple diagram illustrating an exemplary flow of funds from a player to a gaming establishment using the funding system. As can be seen, funds may originate from the player's personal accounts 604, such as bank account(s), credit card(s) or other sources of funding that are held independent of the funding system. These funds may be transferred from a personal account 204 to a funding account 128 of the funding system. As can be seen, the personal account 204 and the funding account 128 belong to the player and thus may be thought of as a personal transfer in that funds are being transferred between accounts owned by the player. There is little or no risk that such transaction's validity would be questioned since each account belongs to the player.

When desired, the player may transfer funds from the funding account 128 to the gaming establishment 136 so that he or she may use the funds to wager or purchase goods or services at the gaming establishment. In a preferred embodiment, the transfer of funds would typically occur between a player's funding account 128 and a player's casino or trust account 604, such as facilitated by the gaming establishment or its financial institution. Thereafter, the player may utilize the funds associated with their casino account 604 to place wagers. At the time wagers are placed, funds are transferred from the player's casino account 604 to the casino or other gaming establishment (such as a bank account belonging to the gaming establishment).

In this configuration, the player's transfer of funds from their funding account 128 to their casino account 604 is verified and is a transfer of funds from one of the player's own accounts to another of the player's own accounts (and thus does not comprise a transfer from the a player's bank account to a third party or merchant which might then be subject to chargeback). Further, the transfer of funds from the player's casino account 604 to the casino's own account (upon the player placing a wager) is not a transfer from a player bank account to a third party, but is instead a transfer of funds from the player's “trust” or casino account to the casino, thereby again avoid issues with chargebacks (which could otherwise arise if the player was transferring funds from a bank account to a third party).

In summary, the funding system effectuates a verified transfer between a player and a casino, and thus accounts having different owners. However, as disclosed above, this verified transfer involves one or more verification steps or processes whereby a fund transfer is verified and confirmed before it is effectuated. In addition, the player transfers funds first between their own accounts, and then to the casino in a manner which is not a bank trasnsfer, thus reducing, if not eliminating potential chargebacks. In this manner, the amount of funds removed from gaming establishment accounts as allegedly improper transfers is also greatly reduced, if not eliminated.

It will be appreciated that the invention may be implemented in various manners other than that described herein. For example, in one embodiment a player may be issued a player card and a funds or debit card. Such cards may comprise physical media bearing identifying information, such as account information stored in electronic format in association with a magnetic stripe. However, a player might be issued a FOB, such as a media having an associated radio frequency identification device (RFID) tag or other media (whether constructed from plastic, paper or other materials) having other associated information (printed text, numbers, bar codes, electronic data, etc.). The system may comprise different types of reading devices depending upon the type of media issued to the player. For example, as indicated above, a gaming machine might be configured with a magnetic stripe card reader or an RFID tag reader to read the media of a player.

It is even possible for the player to not be issued a physical media at all, but simply access their accounts via identifying information such as an account number and the verification information described above. In such an embodiment, the system might include other types of information accepting devices. For example, a gaming machine might be configured with a keypad to accept alpha and/or numeric input from a player of an account number, PIN or the like.

The system may also include such devices apart from a gaming machine. For example, a casino might provide one or more accounts terminals or kiosks which permit a player to transfer funds between their accounts. A player may also be permitted to transfer funds by accessing a server of the system on-line, such as from their home or work computer.

As used herein the terms funds, currency and the like preferably mean government issued of backed monies (such as paper currency or “bills”, coins, or electronic representations of the value thereof). For example, a player might deposit a $100 US bill with their bank, which value is then represented electronically in association with their account. The player may then transfer that value, such as in electronic form, from their personal bank account to the debit account. It will be appreciated that the funds may be represented in various manners, however. For example, relative to casino wagering, funds may be represented as credits having a certain value, such as $0.25. Thus, if a player transfers $100 US in funds from their debit account to their player account, those funds may be represented as 400 credits in their player account, each credit having a value of $0.25.

The system and method of the invention may be utilized to fund various wagering events. For example, a player might fund casino-style gaming machine wagering such as to play slot (video or mechanical) gaming machines or video poker or other gaming machines. A player might also fund table games play, such as play of poker or blackjack games. A player might also fund on-line wagering, such as on-line poker, slot or other types of games. A player might also fund sports wagering such as horse race wagering.

It will be appreciated that the system and method of the invention may be used to transfer funds from a casino to a player's account. In one embodiment, a player may win a wager, such as win a sports wager, obtain a winning slot or poker game outcome or the like, and be awarded winnings. In accordance with the invention, the casino may deposit the winnings to the player's player account. The player may then re-wager those winnings. Alternatively, the player might transfer the funds from their player account to their debit account.

One advantage of this aspect of the invention is that a player may also use their “banking” debit account for other purposes. For example, a player may utilize their bank or debit card at a grocery or retail store and use associated funds to make a purchase. For example, a player might win $1000 at a casino and transfer those funds to their debit account. The player might then use that card to buy $1000 in clothing at a retail store.

The system and method of the invention may also include additional features. For example, in one embodiment, the funding platform 108 may be configured to send confirmation messages to a player each time the player requests a funds transaction. For example, if a player requests that funds be transferred from their funds account to their player tracking account, the funds platform may send a confirmation of the transaction by email, text message or the like, to the player's cell phone, PDA, computer or the like. This confirmation may be sent when a transaction request is received and/or completed, whereby the player is provided real-time confirmation information. This confirmation information also serves as a layer of protection against unauthorized transactions. In one embodiment, the terms of use of the system may be implemented to require a player to challenge transactions within a certain period of time from when they receive such a confirmation, in order to prevent late claims that transactions were not authorized.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A funding system comprising:
a player card server configured to accept application form information and to provide a player tracking account identifier;
a platform server configured to receive the player tracking account identifier from the player card server and a funding account identifier from a financial institution via one or more communications devices, wherein the platform server associates the funding account identifier with the player tracking account identifier; and
one or more access devices configured to receive the player tracking account identifier and to request a fund transfer utilizing the funding account identifier, wherein the fund transfer sends funds from a funding account identified by the funding account identifier to a gaming establishment account.

2. The funding system of claim 1, wherein the funding account is configured to receive funds from a player's personal account.

3. The funding system of claim 2, wherein the funding account and the personal account are both owned by the player.

4. The funding system of claim 1 further comprising a financial server configured to receive the application form information and to provide the funding account identifier.

5. The funding system of claim 1, wherein the player card server is configured to issue a player tracking card to a player.

6. The funding system of claim 1, wherein the one or more access devices are configured to verify the fund transfer at least one time before the funds are transferred from the funding account.

7. The funding system of claim 1, wherein the one or more access devices present a plurality of questions to verify the fund transfer before the funds are transferred from the funding account.

8. The funding system of claim 1, wherein one or more of the one or more access devices are configured to present the application form to one or more players and to accept the application form information.

9. A funding server configured to provide funds to a gaming establishment comprising:
one or more communications devices configured to receive a funding account identifier and a player account identifier, the funding account identifier identifying a particular funding account and the player account identifier identifying a particular player account;
one or more storage devices configured to store the funding account identifier and the player account identifier such that the funding account identifier and the player account identifier are associated with one another; and
one or more processors configured to:
receive the player account identifier and retrieve the associated funding account identifier, wherein the associated funding account identifier is used by the one or more processors to transfer funds from the funding account to a gaming establishment;
verify a transfer of funds with a player one or more times before funds are transferred from the funding account to the gaming establishment.

10. The funding platform of claim 9, wherein the one or more storage devices also store authorization information, the one or more processors configured to provide the funding account identifier along with the authorization information to transfer funds from the funding account to the gaming establishment.

11. The funding server of claim 9, wherein the one or more processors verify the transfer of funds by verifying answers to one or more questions received from a player.

12. The funding server of claim 9, wherein the funding account is owned by a player.

13. The funding server of claim 9, wherein the one or more storage devices also store application form information received from a player.

14. The funding server of claim 13, wherein the application form information includes one or more answers to one or more questions, wherein the one or more processors compare one or more answers from a player with the one or more answers to verify the fund transfer.

15. The funding server of claim 9, wherein the one or more communications devices are in communication with a financial institution's server to communicate transfer instructions to transfer funds from the funding account to the gaming establishment.

16. A method of funding gaming establishment transactions comprising:
receiving player identification information via an application form;
sharing the player identification information with a financial institution to establish a funding account at the financial institution;
providing a player account and player tracking card to a player identified in the player identification information;
associating the player account and funding account together;
receiving a player account identifier from the player tracking card;
verifying a fund transfer by requesting verification information from a player one or more times; and
transferring funds from the funding account associated with the player account identified by the player account identifier.

17. The method of claim 16, wherein verification information is requested a plurality of times.

18. The method of claim 16, wherein the verification information is first received via the application form.

19. The method of claim 16, wherein the funding account is established with the player as its owner.

20. The method of claim 16 further comprising receiving funds at the funding account from a player's personal account.
